(19) United States
(12) Patent Application Publication
(10) Pub. No.: US 2026/0035083 A1
(43) Pub. Date: Feb. 5, 2026

(54) JOINING FLANGE FOR AIRCRAFT NACELLE WITH ZONE OF FLEXIBILITY

(71) Applicants: Airbus (S.A.S.), Blagnac Cedex (FR); Airbus Operations (S.A.S.), Toulouse (FR)

(72) Inventors: Gregory Albet, Toulouse (FR); Julien Sentier, Toulouse (FR); Stéphane Le Clainche, Rochefort (FR); Pauline Dubuc, Toulouse (FR)

(21) Appl. No.: 19/284,900

(22) Filed: Jul. 30, 2025

(30) Foreign Application Priority Data
Jul. 31, 2024 (FR) FR2408459

(51) Int. Cl. B64D 29/06; B64D 33/02

(52) U.S. Cl. CPC B64D 29/06; B64D 33/02

(57) ABSTRACT

A flange for joining an engine compartment to an air intake compartment of an aircraft, having a first leg, referred to as base, shaped to be placed on an outer surface of one of the engine compartment and the air intake compartment, referred to as mounting surface, and a second leg, referred to as joining leg, including at least one orifice for the passage of an element for connecting the joining flange to another flange, which is inclined relative to the base, the joining flange including at least one groove cut into the joining leg to create a local narrowing of the section.

### TECHNICAL FIELD

The disclosure herein relates to a flange for joining an engine compartment to an air intake compartment of an aircraft nacelle.

### BACKGROUND

An aircraft nacelle generally comprises an air intake compartment and an engine compartment that are secured to one another by a connecting device. The connecting device for its part comprises at least two joining flanges mounted one against the other and connected by a set of bolts.

The connecting device has to ensure the integrity of the structure of the nacelle in the event of engine damage, including in the event of blade loss (“Fan Blade Off” or FBO). Blade loss is an event during which a blade of the fan of the jet engine becomes detached from its shaft, which causes therewith damage to the propulsion assembly. Certification requirements require that the intake is not able, under any circumstances, to become detached from the engine and fall to the ground. The connecting device is therefore designed with the objective of satisfying this constraint.

More specifically, if one of the blades of the fan becomes detached, a large amount of energy is released. The engine does not stop its rotation instantaneously and a substantial imbalance is exerted on the structure of the nacelle. This is the phase referred to as “rundown”: the rotation of the fan decreases, but the imbalance causes deformation of the structure. The amount of energy released is first very large and then decreases, and this results, on the structure, in a wave that rotates at the rate of the rotation of the engine. The energy wave, supplied by the imbalance, creates a deformation that varies at the connecting device. The joining flange must then withstand in order for the air intake to remain secured to the jet engine.

A known solution consists in adding additional pieces to the joining flanges and the set of bolts, for example angle bars interposed between the flanges, to absorb the deformation and limit the propagation thereof.

Nevertheless, this solution is tricky to implement and makes the manufacture of the nacelle more complex.

The aim of the disclosure herein is to at least partially remedy these drawbacks.

### SUMMARY

To this end there is proposed a flange for joining an engine compartment to an air intake compartment of an aircraft, having a first leg, referred to as base, shaped so as to be placed on an outer surface of one of the engine compartment and the air intake compartment, referred to as mounting surface, and a second leg, referred to as joining leg, which is inclined relative to the base and comprises at least one orifice for the passage of an element for connecting the flange to another flange, the joining flange comprising at least one groove cut into the joining leg, so as to create a local narrowing of the section.

By virtue of the joining flange according to the disclosure herein, it is possible to absorb the deformation wave in the event of blade loss, the local narrowing of the section that is due to the groove forming a zone of deformation of the flange. Thus, it is the flange itself, by its deformation, that makes it possible to prevent the propagation of deformation in the event of FBO, without it being necessary to add any other piece to the connection between the engine compartment and the air intake compartment.

According to another aspect, the groove extends parallel to a longitudinal edge of the joining leg.

According to another aspect, the groove extends over the entire length of the longitudinal edge of the joining leg.

According to another aspect, the groove extends over only a part of the length of the longitudinal edge of the joining leg.

According to another aspect, the groove extends in a lower half, in terms of height, of the joining leg, when the flange is mounted on the mounting surface.

According to another aspect, the joining leg comprises scallops around the at least one orifice for the passage of a connecting element.

According to another aspect, the flange comprises two grooves, each groove being flush with an opposite face of the joining leg.

It will be noted that each groove is flush with one face of the joining leg without reaching an opposite face of the joining leg.

Another subject of the disclosure herein is a device for connecting an engine compartment to an air intake compartment of an aircraft, comprising a first flange and a second flange, disposed against the first flange, at least one of the first and second flanges being a joining flange as described above, the connecting device comprising a connecting element locked in the at least one passage orifice.

According to another aspect, each of the first and second flanges is a joining flange as described above.

Another subject of the disclosure herein is a nacelle for an aircraft, comprising an engine compartment, an air intake compartment and a connecting device as described above, the engine compartment and the air intake compartment being secured to one another by the connecting device.

Another subject of the disclosure herein is an aircraft, comprising a nacelle as described above.

### BRIEF DESCRIPTION OF THE DRAWINGS

Further features, details and advantages will become apparent upon reading the detailed description below, and analyzing the appended drawings, in which:

FIG. 1 is a schematic cross section on a radial plane of a part of the front of an aircraft comprising a connecting device according to the disclosure herein.

FIG. 2 is a schematic cross section on a radial plane of the connecting device in FIG. 1.

FIG. 3 is a schematic perspective view of a detail of the connecting device in FIG. 1 (comprising a joining flange and a motor-side flange, the latter being partially illustrated).

FIG. 4 is a schematic perspective view of a detail of the connecting device in FIG. 1, according to a variant embodiment.

FIG. 5 is a schematic perspective view of a detail of the connecting device in FIG. 1, according to another embodiment.

### DETAILED DESCRIPTION

The examples and the related conditions detailed here are mainly intended to help the reader understand the principles of the disclosure herein and not to limit its scope to these specific examples and conditions. It will be understood that a person skilled in the art can conceive of various arrangements that, although not explicitly described or depicted here, nevertheless embody the principles of the disclosure herein and are included in its spirit and scope.

Furthermore, for ease of understanding, the following description may describe relatively simplified implementations of the disclosure herein. As a person skilled in the art will understand, other implementations of the disclosure herein may be of greater complexity.

In some cases, examples of modifications of the disclosure herein may also be presented. This is done simply as an aid to understanding, and again not to define the scope or establish the limits of the disclosure herein. These modifications are not an exhaustive list, and a person skilled in the art may make other modifications while still remaining within the scope of the disclosure herein.

Furthermore, all the statements below relating to the principles, aspects and implementations of the disclosure herein, as well as the specific examples thereof, aim to encompass both the structural and functional equivalents thereof, whether they are currently known or developed in the future.

As is apparent from the figures, one subject of the disclosure herein is a joining flange 1 for a connecting device 2 of a nacelle 3 of an aircraft A. The disclosure herein also relates to the connecting device 2 comprising the flange 1.

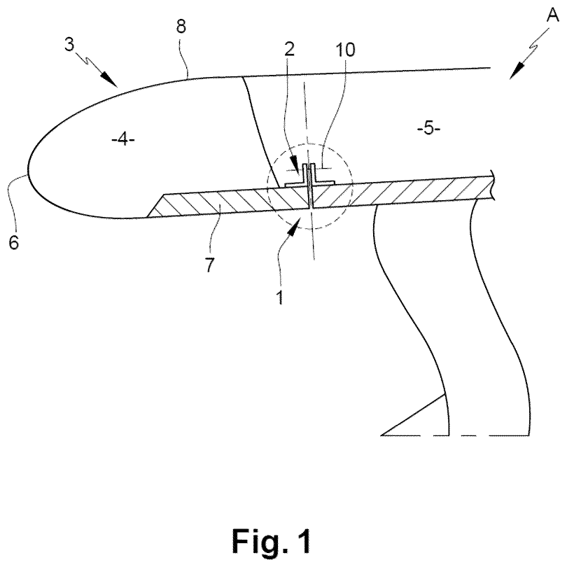

In FIG. 1, the nacelle 3 comprises an air intake compartment 4 and an engine compartment 5, also referred to as a motor, in the extension of the air intake 4. The air intake 4 is disposed at the front of the nacelle 3 and makes it possible to channel an air flow in the direction of the motor 5. The air intake 4 comprises a lip 6 of which the surface in contact with the aerodynamic flows is extended inside the nacelle by an inner duct 7 and outside the nacelle by an outer wall 8. The air intake 4 is connected to the motor 5 by the connecting device 2.

The connecting device 2 comprises the flange 1 disposed on the side of the air intake 4 and a flange 9 disposed on the side of the motor 5, bolts 10 securing the flanges 1, 9 to each other, as will be described in detail below.

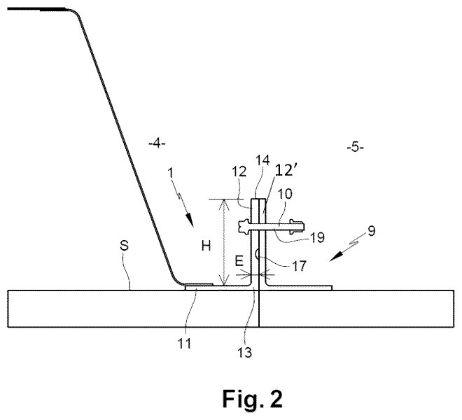

The joining flange 1 will now be described in detail, with reference to FIGS. 2 to 5.

As is apparent from these figures, the flange 1 comprises a first leg, referred to as base, 11 and a second leg 12, referred to as joining leg, which is inclined with respect to the base 11. The base 11 is shaped so as to be placed on an outer surface S of one of the engine compartment 5 and the air intake compartment 4, referred to as mounting surface S.

In the figures, the mounting surface S is the upper surface of the inner duct 7 of the air intake 4.

In the embodiments illustrated, the joining leg 12 is disposed orthogonally to the base 11.

Each of the two legs, the base 11 and the joining leg 12, advantageously has the overall shape of a portion of a circular ring C.

The joining leg 12 is delimited by two opposite longitudinal edges, referenced 13 and 14, and two opposite transverse edges, only one of which, referenced 15, is visible in the figures. The longitudinal edge 13 forms a join with the base 11 and rests on the mounting surface 12, while the longitudinal edge 14 is free. The height H of the ring C is the distance between the longitudinal edges 13 and 14. A thickness E of the ring C is the thickness of the transverse edges and delimits an external face Fe of the joining leg 12 and an internal face Fi of the joining leg 12. The internal face Fi is disposed on the side of the base 11, i.e. towards the air intake 4. The external face Fe is disposed towards the compartment 5, and is shaped so as to be in contact with a joining leg 12′ of the flange 9, as will be described in detail below.

As is apparent from FIGS. 2 to 5, the joining flange 1 comprises at least one groove 17 cut into the joining leg 12 so as to create a local narrowing of the section. In other words, the groove 17 creates a reduction in the thickness E of the joining leg 12.

The groove 17 is for example produced by orbital machining.

The groove may be of any appropriate shape, advantageously of curved, for example semicircular, section, as can be seen in the figures.

By narrowing the section locally, i.e. by reducing the material, a zone of flexibility is generated, which allows the elastic and programmed deformation of the flange 1. Thus, in the event of engine damage, and in particular in the event of blade loss, the flange is deformed by its zone of flexibility, and this allows at least a part of the deformation of the structure to be absorbed.

The number of grooves 17, their dimensions and locations are chosen so as to remain within the limits of plasticity of the flange 1 and not reach the breaking point, even in the event of FBO.

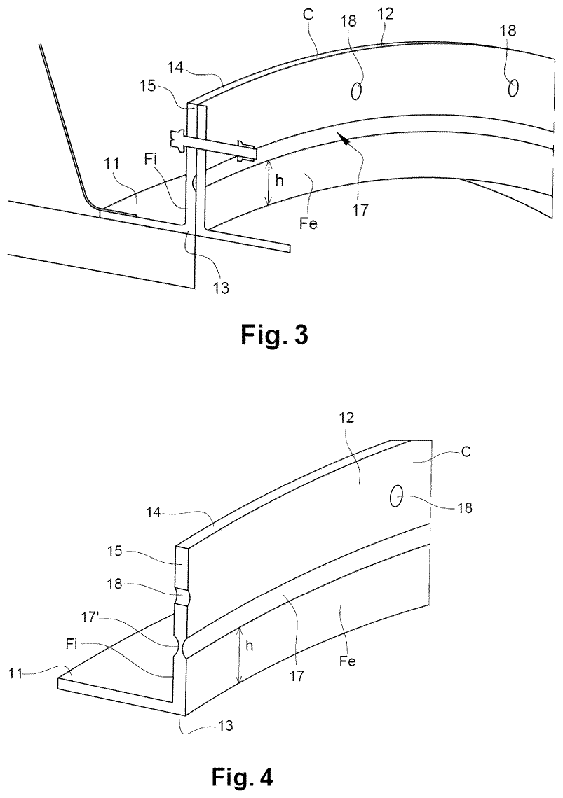

In FIGS. 2 and 3, the flange 1 comprises a single groove 17, extending parallel to the longitudinal edges 13, 14, over the entire circumference of the joining leg 12. The groove 17 is closer to the longitudinal edge 13 than to the longitudinal edge 14, although, as explained above, the disclosure herein is not limited to this position. In FIGS. 2 and 3, the groove 17 is flush with the external face Fe of the joining leg 12.

According to the variant in FIG. 4, the flange 1 comprises, in addition to the groove 17, a groove 17′ that is flush with the internal face Fi of the joining leg 12. The grooves 17 and 17′ are placed face to face. In other words, the grooves 17 and 17′ are cut on either side of the thickness E of the joining leg 12 at one and the same height h.

The disclosure herein is not limited to this variant and the two grooves 17, 17′ may not be disposed at the same height h.

In each of the embodiments illustrated, the joining leg 12 comprises through-orifices 18, for the passage of a shank 19 of a connecting element. The connecting element is for example a bolt 10, the shank 19 being that of a screw, as can be seen in FIGS. 1 to 3. Preferably, the orifices 18 are regularly spaced apart.

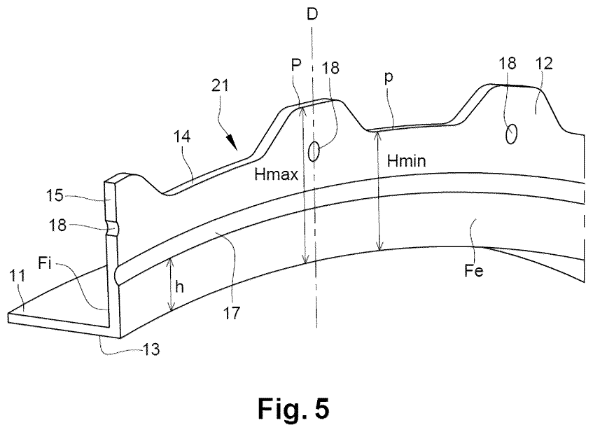

According to the first embodiment, illustrated in FIGS. 2 to 4, the free longitudinal edge 14 is flat, and the height H of the joining leg 12 is constant. According to the second embodiment, illustrated in FIG. 5, the free longitudinal edge 14 comprises cutouts, or scallops, 21, around the orifices 18. In other words, the height H of the joining leg 12 varies longitudinally.

For each orifice 18, D denotes a straight line passing through the orifice 18 and perpendicular to longitudinal edge 13. The height H is greater in line with each orifice 18 (height Hmax) and then decreases symmetrically with respect to the straight line D, between a plateau P at the height Hmax and a plateau p at a height Hmin. The height Hmin corresponds substantially to the level of positioning of the orifices 18.

This embodiment has the advantage of protecting the zone around the bolt by making the flange more flexible overall by virtue of the scallops 21, while at the same time increasing the flexibility of the flange 1, and this reinforces the absorption of the deformation by the flange 1.

The connecting device 2 will now be described.

As already indicated, the connecting device 2 comprises the flange 1 and also the flange 9. The flange 9 is either a flange of the prior art, without a groove 17, or a flange in accordance with the disclosure herein, in which case it has at least one groove 17. The flange 9 is not described in greater detail and reference will be made to the preceding description, which then also applies to the flange 9.

The flanges 1 and 9 are fastened to one another by the bolts 10, the shanks 19 of the screws being inserted into the through-orifices 18 and nuts clamping the screws. The bolts 10 form elements for connecting the flange 1 to the flange 9.

As is apparent from the preceding description, the flange 1 makes it possible to absorb the deformations in the event of blade loss.

Advantageously, the dimensions of the groove 17 (length, diameter) are chosen such that the deformation absorbed by the flange 1 corresponds to the amount of energy released during the FBO.

The flange 1 is particularly suitable for new engine architectures of UHBR (“Ultra-High Bypass Ratio”) type of which the fans are enlarged and for which the amount of energy released during blade loss is even greater. With these engine configurations, the bolts are even more highly loaded in the event of FBO and the flange 1 allows effective protection thereof by virtue of the zone of flexibility. The flange 1 can be deformed in a localized and controlled manner and thus protect the bolts and therefore the join between the air intake 4 and the engine 5.

Moreover, the reduction of material in the zone of flexibility makes it possible to reduce the mass of the flange, and this contributes to lightening the aircraft.

It will be noted that groove is understood to mean any non-through groove. The groove(s) do(es) not pierce right through the material of the joining leg 12, from the face Fe as far as the face Fi or vice versa. On the contrary, material remains between the groove and the face with which the groove is not flush.

Modifications and improvements to the implementations described above of the disclosure herein may occur to a person skilled in the art. In particular, the embodiments and variants described can be combined provided that they are not incompatible. The above description is illustrative by examples rather than limiting. The scope of the disclosure herein is therefore limited solely by the scope of the claims below.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A nacelle for an aircraft, comprising an engine compartment, an air intake compartment and a device for connecting an engine compartment to an air intake compartment of an aircraft, comprising a first flange and a second flange disposed against the first flange, at least one of the first and second flanges being a joining flange, the connecting device comprising a connecting element locked in at least one passage orifice, the engine compartment and the air intake compartment being secured to one another by the connecting device, the joining flange having a first leg, referred to as base, shaped so as to be on an outer surface of one of the engine compartment and the air intake compartment, referred to as mounting surface, and a second leg, referred to as joining leg, comprising at least one orifice for passage of an element for connecting the joining flange to another flange, which is inclined relative to the base, the joining flange comprising at least one groove cut into the joining leg, so as to create a local narrowing.

2. The nacelle according to claim 1, wherein the groove extends parallel to a longitudinal edge of the joining leg.

3. The nacelle according to claim 2, wherein the groove extends over an entire length of the longitudinal edge of the joining leg.

4. The nacelle according to claim 2, wherein the groove extends over only a part of the length of the longitudinal edge of the joining leg.

5. The nacelle according to claim 1, wherein the groove extends in a lower half, in terms of height, of the joining leg.

6. The nacelle according to claim 1, wherein the joining leg comprises scallops around the at least one orifice for the passage of a connecting element.

7. The nacelle according to claim 1, comprising two grooves, each groove being flush with an opposite face of the joining leg.

8. The nacelle according to claim 1, wherein each of the first and second flanges is a joining flange.

9. An aircraft comprising the nacelle according to claim 1.
